(19) United States
(12) Patent Application Publication
(10) Pub. No.: US 2023/0274263 A1
(43) Pub. Date: Aug. 31, 2023

(54) POINT-OF-SALE (POS) SYSTEM FOR AUTOMATICALLY CONVERTING TRANSACTIONS INTO CRYPTOCURRENCY

(71) Applicant: Orbix LLC, Dearborn Heights, MI (US)

(72) Inventors: Mohamad Hamade, Dearborn, MI (US); Samatha Bevins, Canton, MI (US)

(73) Assignee: Orbix LLC, Dearborn Heights, MI (US)

(21) Appl. No.: 18/308,059

(22) Filed: Apr. 27, 2023

(51) Int. Cl. G06Q 20/38; G06Q 20/20; G06Q 20/02; G06Q 20/36

(52) U.S. Cl. CPC G06Q 20/381; G06Q 20/027; G06Q 20/204; G06Q 20/3678; G06Q 2220/00

(57) ABSTRACT

A Point-Of-Sale (POS) system for automatically converting transactions into cryptocurrency at a merchant terminal is provided in the present invention. Where the system permits a customer to pay in any currency and a merchant receives FX on blockchain or cryptocurrency rather than traditional currency. Further, the present invention removes barriers to transactions that might inhibit international commerce, or commerce with certain types of currency.

### FIELD OF THE INVENTION

The present invention relates to an application program interface (API) that simultaneously transacts fiat currency (FX currency) to a FX blockchain or cryptocurrency, and more particularly, the application program interface (API) allows merchants to integrate in to their Point-Of-Sale (POS) system for automatically converting transactions into cryptocurrency.

### BACKGROUND OF THE INVENTION

Traditional forms of payment such as via credit card, debit card, cash, internet banking and check are widely recognized as the preferred methods of payment for transactions. A typical payment card transaction with a merchant involves several steps (e.g., payment card authorization, clearing, and settlement) and the participation of various entities (e.g., financial institutions, payment card companies, and payment processing networks). Sometimes, there are processing delays faced by the merchant due to these steps.

In the last few years, a large number of the population worldwide has started using cryptocurrencies. Cryptocurrency is on the verge of getting broad acceptance as a form of payment for goods or services. Holders of the cryptocurrencies are not tied to any government, are decentralized, and allow direct transactions, while still maintaining the trust and stability of fiat currencies. However, despite the popularity of cryptocurrencies to date, existing solutions for processing payments for e-commerce transactions suffer from several drawbacks. Because many merchants are still reluctant to accept or even provide cryptocurrency as an option or a service to customers. This reluctance is largely based on the price variations in the value of cryptocurrency, which can substantially fluctuate from hour to hour or even minute to minute.

U.S. Pat. No. US10055715B1 discloses accepting virtual currencies in a point of sale transaction. The disclosed technology provides payment service capable of accepting a greater diversity of currencies including fiat currencies (US dollars, Euro, Rupee, etc.), and non-fiat currencies including virtual currencies including cryptocurrencies (Bitcoin, ether, etc.), commercial paper (loans, contracts, forms, etc.), and securities (stocks, bonds, derivatives, etc.), than a traditional payment system in a transaction between a customer and a merchant, and specifically for a payment service to solve or ameliorate problems germane to transactions with such currencies. Specifically, the payment service described herein can facilitate transactions, allowing a customer to pay in any currency of their choice, while the merchant can receive payment in a currency of their choice.

U.S. Pat. No. US10055715B1 discloses a closed loop platform for dynamic currency conversion. The invention eliminates currency discrepancy during resource exchange and provides a dynamic currency conversion in real-time for interactions, via a closed loop platform. Using closed loop processing, the invention verifies and authorizes resource transfers, bypassing current currency conversion processing.

U.S. Publication No. US20190236561A1 discloses an Application Programming Interface (API) that is provided on a Point-Of-Sale (POS) terminal for processing a cryptocurrency transaction and a government-backed currency transaction. The POS terminal interacts with a cryptocurrency exchange during the cryptocurrency transaction.

However, these current mechanisms allow merchants to accept cryptocurrency as payment for goods or services rely on merchants directly integrating with cryptocurrency exchanges on a one-to-one relationship basis. Such mechanisms do not offer credit card, debit card or store value wallets as alternative payment options. It is therefore difficult for merchants to offer cryptocurrency as an integrated payment option, alongside other payment methods, to customers. In such conditions merchants have to develop their own integrated payment page, and it may not be possible for all transactions performed on the merchant’s e-commerce site to be settled in real time.

Another drawback with these current mechanisms, is that the way merchants integrate with cryptocurrency exchanges are different from the way they integrate with payment gateways to accept payments with credit card, debit card or store value wallets.

Existing exchanges permit digital wallet to wallet transfers, purchases of digital currencies with government-backed currency, and conversion from a digital currency back to a government-backed currency. But in many cases, either customers or merchants have to bear the price valuation risks encountered with transactions performed by the exchanges. Also dependent on the exchange-rate and fees that are charged by the exchanges at the time when the transaction takes place.

In view of this background, there is a need for a secure system that can allow merchants to integrate in to their POINT-OF-SALE (POS) systems for automatically converting transactions into cryptocurrency, and having an advance exchange platform to at least partially address or ameliorate one or more of the above disadvantages, or at least provide a useful alternative.

### SUMMARY OF THE INVENTION

In order to solve the above problems, the present invention provides a Point-Of-Sale (POS) system and a method for automatically converting transactions into cryptocurrency in real time. A cryptocurrency is a digital currency designed to work as a medium of exchange through a computer network that is not reliant on any central authority, such as a government or bank, to uphold or maintain it. The term cryptocurrency as used herein further includes traditional decentralized cryptocurrencies that have innate value due to the software relied upon by such cryptocurrency, as well as digital currencies issued by a central authority which are pegged in value to a specified fiat currency, a weight of precious metal, or other commodity in terms of value. Cryptocurrency, as used herein, further includes central bank digital currencies which are digital currencies issued by any central bank, or similar authority.

In the aspects/embodiments of the present invention provides a Point-of-Sale (PoS) system for automatically converting transactions into cryptocurrency, the system comprising an Application Program Interface (API) integrated with a Point-of-Sale (PoS) terminal, where an Application Program Interface (API) comprises a payment gateway, a transaction manager and an exchange terminal and being configured to: determine, by the payment gateway in communication with the point of sale terminal of a merchant, that the merchant has selected to receive payment in the cryptocurrency in order for a transaction, receive a payment request from a customer for a transaction amount, execute the transaction through a payment gateway, receive the transaction amount at an exchange terminal, where the transaction amount is converted into a cryptocurrency, and provide the cryptocurrency in a custodial wallet of a merchant, wherein the payment request comprise a request for the transaction amount through a debit/credit card to a merchant account, whereas the transaction amount is automatically transferred in the custodial wallet of the merchant in form of the cryptocurrency as an equivalent of the transaction amount.

In one aspect of the present invention the Point-Of-Sale (POS) system permits a customer to pay in any currency and a merchant receives fiat currency (FX currency) on a blockchain or a cryptocurrency rather than traditional currency. Further, the present invention removes barriers to transactions that might inhibit international commerce, or commerce with certain types of currency. FX is defined as any fiat or governmental currency, or representation thereof, that is traded on Forex markets.

An important advantage of the present invention is that it overcomes a major disadvantage of traditional transactions faced by merchants from the financial companies, which are known for processing delays.

Another important advantage of the present invention is that it overcomes a major disadvantage of cryptocurrency transactions on many public blockchain, which are known for long transaction times.

The summary of the invention is not intended to limit the key features and essential technical features of the claimed invention, and is not intended to limit the scope of protection of the claimed embodiments.

### BRIEF DESCRIPTION OF THE DRAWINGS

The object of the invention may be understood in more detail and particular description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 is an example of a Point-of-Sale (PoS) system for automatically converting transactions into cryptocurrency in accordance with the present invention;

FIG. 2 is a flow chart of an example method of automatically converting transactions into cryptocurrency in accordance with the present invention;

FIG. 3 is another example method of automatically converting transactions into cryptocurrency in accordance with the present invention; and

FIGS. 4a to 4f are user interfaces displayed in a customer browser during the method in accordance with the present invention.

### DETAILED DESCRIPTION OF THE INVENTION

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a”, “an” and “the” are intended to include the plural forms as well, unless the context clearly indicates otherwise.

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. \

Prior to a description with reference to the drawings, to help understanding of the present invention, terms used in this specification are described in brief.

As used herein the terms “customer,” “consumer,” and “user” may be used synonymously and interchangeably.

The term “Payment gateway” as used herein refers to a payment terminal that sits in between a customer and a merchant and ensures that funds are transferred securely and correctly when a transaction is performed.

The term “FX blockchain” as used herein refers to virtual/ digital currencies/ Cryptocurrencies i.e. Bitcoin which is a form of electronic money created from code using an encrypted string. Ownership of cryptocurrency is usually recorded in a cryptographically encrypted immutable sequence of data blocks called a blockchain. The cryptocurrencies allow owners to maintain anonymity and privacy because ownership is linked to a wallet address which is usually just a cryptographic public key.

The term “exchange terminal” is an exchange system for financial transactions on blockchain systems .It also provide means to trade cryptocurrencies with traditional currencies.

Throughout this description reference may be made toward specific currencies such as Bitcoin or the United States dollar (USD). Such references will be understood to be merely examples of other currencies. For example, references to Bitcoin should be understood to be interchangeable for any cryptocurrency, and particularly cryptocurrencies recorded on a blockchain. References to the United States dollar should be understood to be interchangeable for any fiat currency managed by a central authority, such a country (United States, Japan, Canada, China, etc.).

Specifically, the present technology permits a customer to pay in any currency, while permitting the merchant to receive FX on blockchain or cryptocurrency rather than traditional currencies. In this way, the technology provides benefits that remove barriers to transactions that might inhibit international commerce, or commerce with certain types of currency.

Additionally, the present technology, through the presence of a trusted payment service, can increase trust in transactions taking place in multiple currencies.

Such increased trust can also be an important benefit of the present technology when a customer/merchant to the transaction wishes to remain anonymous.

Additionally, the present technology allows merchants to receive transactions and by-pass traditional transaction processing.

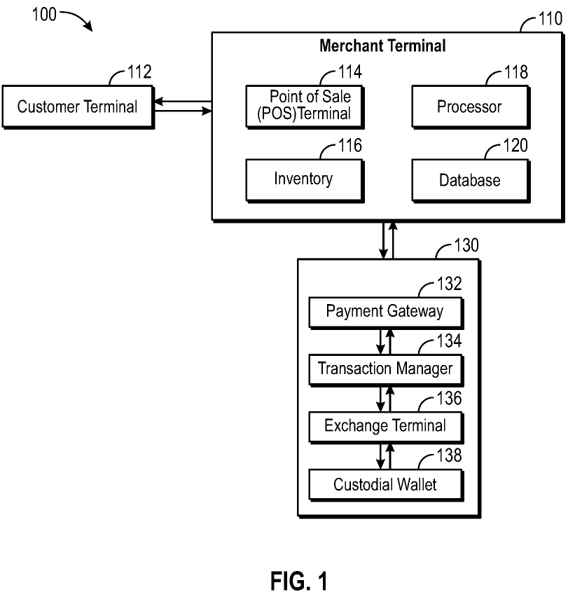

FIG. 1 is a Point-of-Sale (PoS) system for automatically converting transactions into cryptocurrency according to an embodiment of the present invention. The system 100 may be implemented as software executing in an application program interface (API) 130 integrated at a merchant terminal 110 communicating with one another over a network. The merchant terminal 110 comprises a customer terminal 112, a Point-of-Sale (PoS) terminal 114, an inventory 116, a processor 118 and a database 120. The application program interface (API) 130 comprises a payment gateway 132, a transaction manager 134, an exchange terminal 136, and a custodial wallet 138. The various components are illustrated and the arrangement of the components is presented for purposes of illustration only. It is to be noted that other arrangements with more or less components are possible without departing from the scope of the invention.

The techniques, methods, and system presented herein and below for Point-of-Sale (PoS) system for automatically converting transactions into cryptocurrency can be implemented in whole or in part in one, all, or some combination of the components shown with the system 100. The techniques and methods are programmed as executable instructions in memory and/or non-transitory computer-readable storage media and processed on one or more processors associated with the various components.

The application program interface (API) 130 is for transaction processing, according to the embodiments of the present invention. The components of application program interface (API) 130 are programmed and reside within memory and/or a non-transitory computer-readable medium and execute on one or more processors of the devices of the merchant terminal 110.

The application program interface (API) 130 is configured to execute on the processor 118 as executable instructions that perform transactions for purposes of purchasing goods or services or conducting financial transactions.

Further the system 100 includes one or more computer-readable non-transitory storage media for settling a point of sale transaction between a customer and a merchant, wherein the customer transact via debit/credit card and the merchant receives in cryptocurrency, the media embodying software that is operable when executed to: determine, by a payment service in communication with a point of sale system of a merchant, that the merchant has selected to receive payment in the cryptocurrency in order to settle the point of sale transaction.

The system 100 may start by receiving a request from customers at customer terminal 112 on the merchant terminal 110, adding the shopping items from the inventory 116, initiating a payment request at the payment gateway 132. The payment request may comprise a request for the payment through debit/credit card to the merchant account, whereas the transaction amount is automatically transferred in the custodial wallet 138 of the merchant in the form of cryptocurrency as an equivalent of the paid amount.

It is a simple process. Just like any process with transacting debit and credit cards however the merchant will be able to receive cryptocurrency and/or tether without having to do anything on their end. There is a designated wallet address for the merchant to receive their funds. The system 100 may generate a wallet address representing the risk assessment for the payment request.

The application program interface (API) 130 is integrated to the merchant terminal 110 to select the amount to transfer the equivalent cryptocurrency amount to the custodial wallet 138.

The application program interface (API) 130 is enhanced with the transaction manager 134 for performing transactions. That is, rather than deploying a specialized cryptocurrency terminal as dedicated hardware, the transaction manager 134 permits transactions and establishes network connections and communicates directly with the exchange terminal 136 during transactions in real time.

Further, funds are maintained on merchant’ s custodial wallet 138. The merchant can choose to cash out their money directly to their federal or state institutions rather than waiting on payment processing companies. In this way, the system 100 of the present invention provides the amount in real time and eliminates the extra charges incurred by the payment processing companies as well as eliminates the processing delays as faced by the merchant.

In these embodiments, the system 100 may further authenticate the customer, and the merchant. So in the preferred embodiment, the transaction amount is automatically transferred to the custodian wallet 138 instead of merchant’s bank account.

In one embodiment, the present invention provides its own exchange terminal 136, and the exchange terminal 136 will act as a bank, where as soon as a transaction happens, the transaction amount goes to the custodial wallet 138. Hence one advantage of the present invention is that the system 100 eliminates the processing delays caused in the existing art. In an alternate embodiment but not necessarily, the system 100 also provides an optional toggle tap to select the transactions amount to be transferred whether to the custodial wallet 138 or the bank account of the merchant.

Alternatively, the invention, the exchange terminal 136 as cryptocurrency exchange service is invoked for the custodial wallet 138, which trades the particular cryptocurrency stored in the wallet 138 of the merchant in different types of currencies.

The wallet 138 of the merchant can be integrated with a crytpocurrency tumbler to pool together source funds from multiple inputs for a random period of time, and then splitting them back out to destination blockchain addresses. This preserves anonymity of the merchant’s transactions with customers.

In a variation of this embodiment, the wallet 138 has a coin tumbler integrated therein and the destination blockchain addresses include smart contract addresses that convert cryptocurrencies on a first blockchain to other cryptocurrencies on at least one other blockchain. In a further variation of this embodiment, the cryptocurrency tumbler utilizes interblockchain (IBC) protocols such as those utilized on the Cosmos™ blockchain to enable automated IBC transactions via a smart contract, and then the tumbler tumbles the cryptocurrencies on a second blockchain. Tumbling cryptocurrencies on more than one blockchain can preserve privacy of transactions.

An example of a smart contract programmed in solidity can be deployed on the Etherium blockchain to utilize IBC transfers.

pragma solidity ^{^}0.8.0;
import “. /IBC. so1”;
contract IBCExample {
IBC ibc = IBC(0x<IBC contract address>) ; // Replace with the
address of the IBC contract event TransferInitiated(address sender, uint256 amount) ;
function receiveFunds() external payable {
emit TransferInitiated(msg.sender, msg.value);
ibc. transfer(“cosmos1<sender address>”, “osmo1<recipient
address>”, msg.value);
}
}

This example can be modified to suit particular needs of a POS system operator. In another embodiment, the smart contract can convert any cryptocurrency into a privacy token such as Monero™, revert the conversion, and send the cryptocurrency back to the holder at a fresh new cryptocurrency blockchain address.

In an example of an Etherium mixing protocol that can be utilized by the present invention, the following code implements a basic mixing protocol that allows any customer payment, once converted into Etherium cryptocurrency, to be automatically mixed to keep customer transactions private and custodial wallet addresses anonymous.

pragma solidity ^0.8.0;
contract EthMixingProtocol {
address payable public owner;
uint256 public depositFee;
uint256 public mixingFee;
uint256 public mixingDelay;
mapping (address => uint256) public deposits;
mapping (address => uint256) public withdrawalRequests;
event Deposit(address indexed user, uint256 amount);
event WithdrawalRequested(address indexed user, uint256 amount) ;
event Withdrawal(address indexed user, uint256 amount) ;
constructor () {
owner = payable (msg. sender) ;
depositFee = 0.001 ether;
mixingFee = 0.005 ether;
mixingDelay = 1 days;
}
modifier only0wner() {
require (msg. sender == owner, “Only owner can call this
function. ”) ;
_;
}
function deposit() external payable {
require (msg. value > 0, “Deposit amount must be greater than
zero. ”) ;
uint256 fee = msg. value * depositFee / 100;
deposits [msg. sender] += msg.value - fee;
emit Deposit (msg. sender, msg. value) ; }
function requestWithdrawal(uint256 amount) external {
require (amount > 0, “Withdrawal amount must be greater than
zero. ”) ;
require (deposits [msg. sender] >= amount, “Not enough deposited
funds. ”) ;
deposits [msg. sender] -= amount;
withdrawalRequests [msg. sender] = block. timestamp +
mixingDelay;
emit WithdrawalRequested (msg. sender, amount); }
function withdraw() external {
require (withdrawalRequests [msg. sender] > 0, “No withdrawal
request pending. ”) ;
require (block. timestamp >= withdrawalRequests [msg. sender],
“Withdrawal delay has not elapsed. ”) ;
uint256 amount = deposits [msg. sender] ;
uint256 fee = amount * mixingFee / 100;
deposits [msg. sender] -= amount + fee;
payable (msg. sender). transfer (amount) ;
emit Withdrawal (msg. sender, amount) ; }
function setDepositFee(uint256 newFee) external onlyOwner {
depositFee = newFee; }
function setMixingFee(uint256 newFee) external onlyOwner {
mixingFee = newFee;
}
function setMixingDelay(uint256 newDelay) external onlyOwner {
mixingDelay = newDelay;
}
function withdrawFees() external onlyOwner {
payable (owner). transfer (address (this). balance) ;
}
}

In this implementation, the owner of the contract can set the deposit fee, mixing fee, and mixing delay using the setDepositFee, setMixingFee, and setMixingDelay functions, respectively. Users can deposit ETH using the deposit function, which subtracts a small deposit fee and stores the deposited amount in the deposits mapping. Users can then request a withdrawal using the requestWithdrawal function, which sets a withdrawal delay and stores the requested withdrawal amount in the withdrawalRequests mapping. After the withdrawal delay has elapsed, users can withdraw their funds (minus the mixing fee) using the withdraw function.

Note that this exemplary implementation is not very secure and may be circumvented by an attacker with knowledge of the deposit and withdrawal addresses. A more sophisticated implementation would likely use more advanced cryptographic techniques to obfuscate the source of the funds.

It should be appreciated that a typical POS (point of sale) terminal 114 as envisioned herein includes a touchscreen monitor, a barcode scanner for scanning barcodes on retail goods, a cash drawer for holding cash, a magnetic stripe reader for reading magnetic strips, a chip reader, a receipt printer for printing a record of any transaction, and a display pole for displaying data to a customer standing at the POS terminal. The touchscreen monitor is capable of displaying a bar code for receiving digital payments from a handheld device such as a smart phone. These components are functionally integrated and controlled by a processor. The system 100 is connected via hardware to a communications network such as the internet. The coin mixer can be integrated in the form of software, firmware, hardware, or provided by a third party via an internet connection.

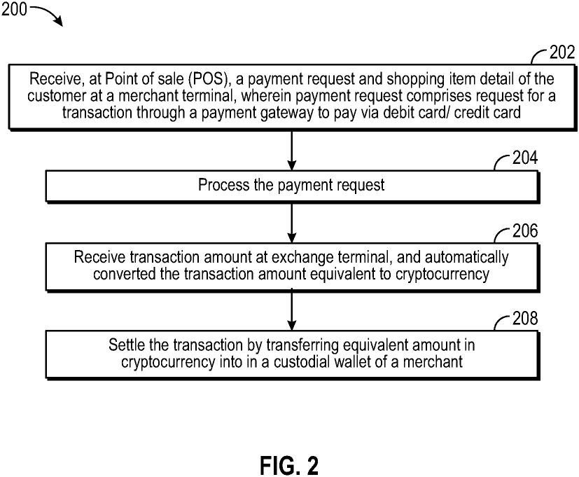

FIG. 2 shows an exemplary method 200 according to an embodiment of the present invention, where the method 200 starts at step 202 by receiving, at Point of sale (POS), a payment request and shopping item detail of the customer at the merchant terminal 110, wherein payment request comprises request for a transaction through a payment gateway to pay via debit card/ credit card. Next, at step 204, start processing the payment request. At step 206, receive the transaction amount at the exchange terminal 136, and automatically convert the transaction amount equivalent to cryptocurrency. At step 208, the system 100 settles the transaction by transferring equivalent amount in cryptocurrency into the custodial wallet 138 of a merchant.

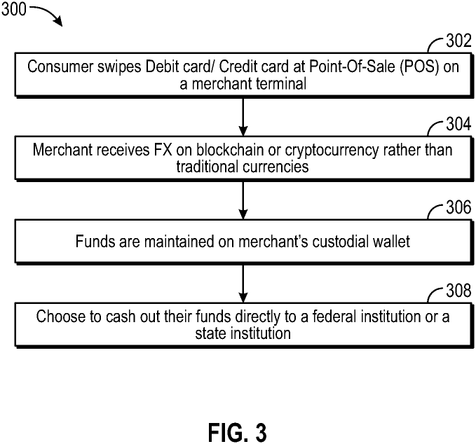

FIG. 3 shows another exemplary method 300 according to an embodiment of the present invention, where the method 300 starts at step 302 by receiving, at the payment gateway 132, a payment request and shopping basket details of a customer, where the customer swipes Debit card/ Credit card at Point-Of-Sale (POS) on the merchant terminal 110. Next, at step 304 the Merchant receives FX on blockchain or cryptocurrency rather than traditional currencies. At step 306, Funds are maintained on merchant’s custodial wallet 138. And at step 308, the merchant may choose to cash out their money directly to their federal institutions or state institutions rather than waiting on payment processing companies. For the cannabis industry, this is a solid loophole to deposit their funds into federal institutions through a crypto exchange/custodial wallet.

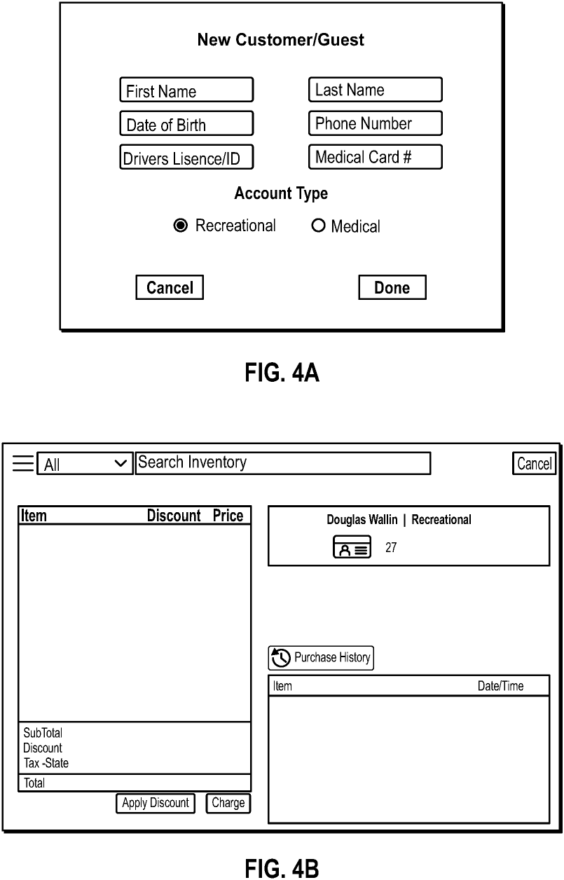

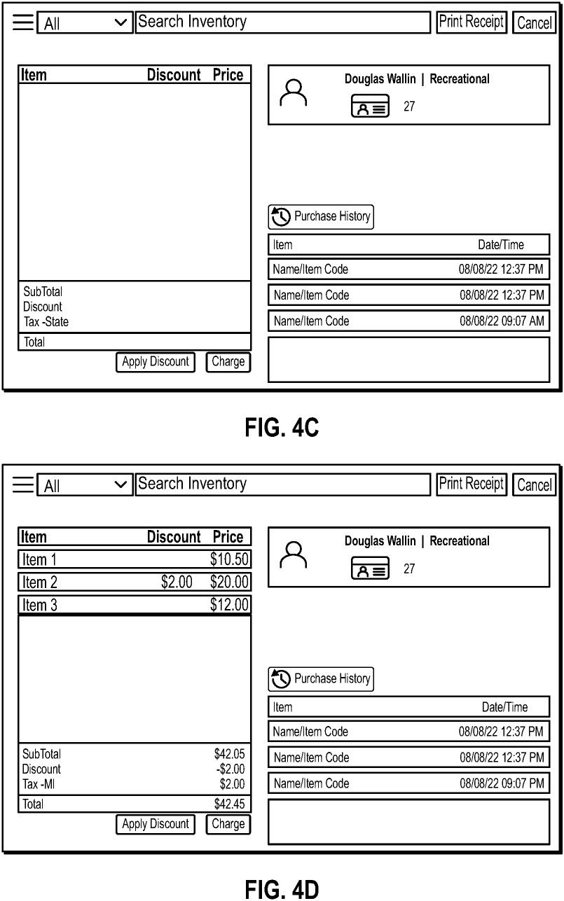

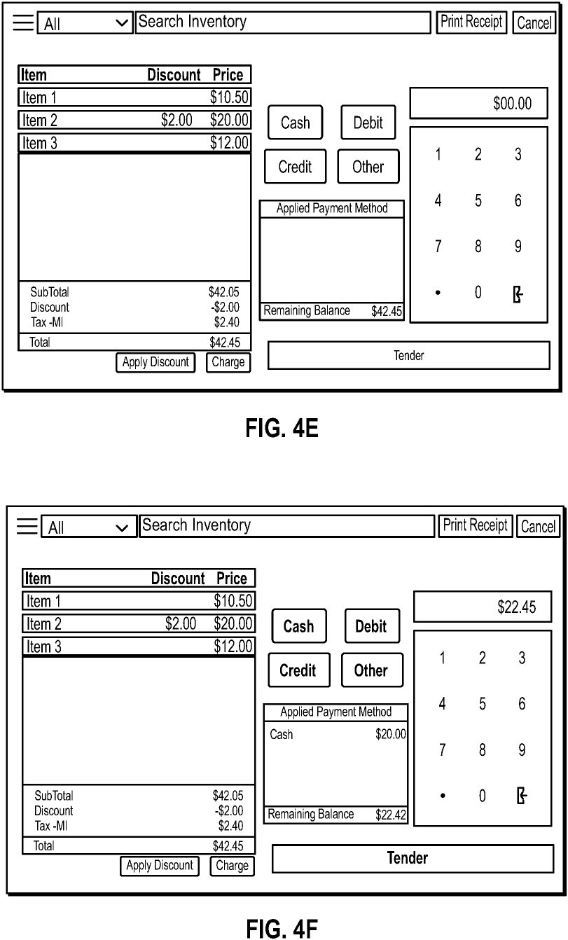

FIG. 4a shows a login/signup page for registration on the interface, where a customer enters the details before shopping. Once a customer is registered, the merchant landing page is displayed as shown in FIG. 4b. FIG. 4c shows the purchase history of the customer by means of scanning customer ID. FIG. 4d shows that the customer items are added along with the prices, which are performed by searching through the inventory. FIG. 4e shows the payment option through different modes of payments. FIG. 4f shows the total amount of the payment request, then the customer may make a transaction and the transaction amount is automatically converted into cryptocurrency and the same is reflected in the custodial wallet 138 of the merchant. Where the merchant can choose to cash out their money directly to their federal or state institutions rather than waiting on payment processing companies.

An important advantage of the present invention is that it overcomes a major disadvantage of traditional transactions faced by merchants from the financial companies, which are known for processing delays.

Another important advantage of the present invention is that it overcomes a major disadvantage of cryptocurrency transactions on many public blockchain, which are known for long transaction times.

The embodiments of the invention described herein are implemented as logical steps in one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

1. A computer-implemented method for performing transaction at Point-of-Sale (PoS) for a merchant, the method comprising:
providing an Application Program Interface (API) at a merchant terminal, where the Application Program Interface (API) is integrated with a Point-of-Sale (PoS) terminal, and being configured for;
receiving a payment request from a customer for a transaction amount via a credit or debit card,
executing the transaction through a payment gateway,
receiving the transaction amount at an exchange terminal, where the transaction amount is converted into a cryptocurrency and mixed in a cryptocurrency mixer, and
providing the cryptocurrency in a custodial wallet of a merchant.

2. The method claim 1, wherein providing the cryptocurrency in the custodial wallet of the merchant in real time.

3. The method claim 1, wherein the conversation of the transaction amount into the cryptocurrency is automatic process without having to do anything from the merchant.

4. A method of transaction at Point-of-Sale (PoS), the method comprising;
swiping a debit/ credit card for a transaction amount by a customer at a Point-of-Sale (PoS) terminal;
automatically converting the transaction amount into a cryptocurrency and mixing the cryptocurrency; and
receiving the transaction amount in form of the cryptocurrency in a custodial wallet of a merchant.

5. A method of claim 4, wherein the merchant can choose to cash out the cryptocurrency directly to a federal institution or a state institution rather than waiting on payment processing company.

6. A Point-of-Sale (PoS) system for automatically converting transactions into cryptocurrency, the system comprising an Application Program Interface (API) integrated with a Point-of-Sale (PoS) terminal, where an Application Program Interface (API) comprises a payment gateway, a transaction manager and an exchange terminal and being configured to:
determine, by the payment gateway in communication with the point of sale terminal of a merchant, that the merchant has selected to receive payment in the cryptocurrency in order for a transaction,
receive a payment request from a customer for a transaction amount,
execute the transaction through a payment gateway,
receive the transaction amount at an exchange terminal, where the transaction amount is converted into a cryptocurrency, and
provide the cryptocurrency in a custodial wallet of a merchant,
wherein the payment request comprise a request for the transaction amount through a debit/credit card to a merchant account, whereas the transaction amount is automatically transferred in the custodial wallet of the merchant in form of the cryptocurrency as an equivalent of the transaction amount.

7. The system of claim 6, wherein the transaction manager permits transaction, and establishes network connections and communicates directly with the exchange terminal during transactions in real time.

8. The system of claim 6, wherein the transaction amount is automatically transferred in the custodial wallet of the merchant in form of cryptocurrency as an equivalent of the transaction amount.

9. The system of claim 6, wherein the merchant receives the transaction amount in form of cryptocurrency in the custodial wallet in real time.

10. The system of claim 6, wherein the custodial wallet has a designated wallet address for the merchant to receive transactions.
